(19) United States
(12) Patent Application Publication
(10) Pub. No.: US 2020/0197832 A1
(43) Pub. Date: Jun. 25, 2020

(54) Method and Apparatus for Determining One or More Buffer Composition Recipes

(71) Applicant: GE Healthcare Bio-Sciences AB, Jppsala (SE)

(72) Inventor: Enrique Napoleone Carredano, Uppsala (SE)

(21) Appl. No.: 16/620,923

(22) PCT Filed: Jun. 15, 2018
(86) PCT No.: PCT/EP2018/066005

§ 371 Date: Dec. 10, 2019

(30) Foreign Application Priority Data
Jun. 15, 2017 (GB) 1709531.6

(51) Int. Cl. B01D 15/16; G01N 30/34; G01N 30/86

(52) U.S. Cl. CPC B01D 15/166; G01N 30/8658; G01N 30/34

(57) ABSTRACT

The present invention relates to an apparatus, a method, a computer program and a computer program product for determining one or more buffer composition recipes. The method comprising obtaining design of experiment, DoE, data, wherein the DoE data is indicative of a set of buffer compositions and corresponding unique recipes, wherein the set of buffer compositions is selected as a subset from a total set of buffer compositions within a design range, running a first set of experiments by consecutively providing buffer compositions mixed according to each unique recipe indicated by the DoE data as the only input to the chromatography apparatus, obtaining results of experiment, RoE, data as output from the chromatography apparatus, wherein the RoE data is indicative of at least a potential of hydrogen, pH, value and a conductivity value of each buffer composition of the set of buffer compositions, obtaining prediction of experimental, PoE data indicative of at least a predicted pH value and a predicted conductivity value of each buffer composition of the total set of buffer compositions, obtaining a first objective function, the first objective function being dependent on a pH value and a conductivity value, selecting a second subset from the total set of buffer compositions which corresponding pH values and conductivity values optimize the first objective function, determining the one or more buffer composition recipes for chromatography of a chemical sample as the unique recipes corresponding to the second subset. The present invention further relates to an apparatus, a computer program and a computer program product.

### TECHNICAL FIELD

The present invention relates to an apparatus, a method, a computer program and a computer program product for determining one or more buffer composition recipes. In particular, buffer composition recipes for a chromatography apparatus configured for performing chromatography.

### BACKGROUND

Chromatography is a well-known procedure for analyzing and preparing chemical mixtures or chemical samples. The sample may typically be dissolved in a fluid, referred to as a buffer composition. The various sample components of the mixture travel at different speeds, causing them to separate. This separation may be used to separate the sample components in a fractionation step where the mobile phase may be directed to different containers, e.g. by an outlet valve of the chromatography apparatus.

The selection of the buffer composition used will greatly influence the quality of the output from the chromatography process, e.g. a purity and/or yield of a wanted sample component. In particular, the potential of hydrogen, pH, value and conductivity of the buffer is of importance.

In some existing preparation or production systems for buffer compositions, buffer components are mixed into a buffer composition according to a recipe or molar recipe, thereby obtaining a buffer composition having a wanted pH or conductivity. A drawback of such systems is that if the recipe is not known, a substantial effort must be made by means of testing, to determine buffer composition recipes or to find out the fractions of buffer components in a recipe resulting in a buffer composition having a wanted pH or conductivity. This means that large amounts of resources are wasted, in the form of man-hours and wasted buffer components.

Further, some existing commercial software systems may be able to determine buffer composition recipes. A drawback with such systems is that their accuracy is compromised when salts, additives and multiple buffers are used at different concentrations. To the extent that such systems may consider such effects, their accuracy is acceptable only for a relatively small number of combinations of buffer composition components and buffer composition concentrations.

Thus, there is a need for an improved apparatus, in particular in laboratory scale, and a method for determining one or more buffer compositions and corresponding buffer composition recipes for performing chromatography.

### OBJECTS OF THE INVENTION

An objective of embodiments of the present invention is to provide a solution which mitigates or solves the drawbacks and problems described above.

### SUMMARY OF THE INVENTION

The above and further objectives are achieved by the subject matter described herein. Further advantageous implementation forms of the invention are further defined herein

According to a first aspect of the invention, the above mentioned and other objectives are achieved with a method for determining one or more buffer composition recipes for a chromatography apparatus configured for performing chromatography. The method comprising obtaining design of experiment, DoE, data, wherein the DoE data is indicative of a set of buffer compositions and corresponding unique recipes, where the set of buffer compositions is selected as a subset from a total set of buffer compositions within a design range, running a first set of experiments by consecutively providing buffer compositions mixed according to each unique recipe indicated by the DoE data as the only input to the chromatography apparatus, obtaining results of experiment, RoE, data as output from the chromatography apparatus, wherein the RoE data is indicative of at least a potential of hydrogen, pH, value and a conductivity value of each buffer composition of the set of buffer compositions, obtaining prediction of experimental, PoE data, wherein the PoE data is indicative of at least a predicted pH value and a predicted conductivity value of each buffer composition of the total set of buffer compositions, obtaining a first objective function, the first objective function being dependent on a pH value and a conductivity value, selecting a second subset from the total set of buffer compositions which corresponding pH values and conductivity values optimize the first objective function, determining the one or more buffer composition recipes for chromatography of a chemical sample as the unique recipes corresponding to the second subset from the total set of buffer compositions.

At least an advantage of the invention according to the first aspect is that a buffer composition/s or buffer composition/s recipe/s is/are obtained in reduced time and with reduced complexity by obtaining the a buffer composition through automated experiments. A further advantage is that the amount of wasted buffer components may be reduced by using the method according to the invention.

In a first embodiment according to the first aspect, each unique recipe 100 indicated by the DoE data 210 is at least indicative of a first fraction 111 of a first fluid 110, a second fraction 121 of a second fluid 120 and a third fraction 131 of a third fluid 130.

At least an advantage of the invention according to the first embodiment is that an improved buffer composition/s or buffer composition/s recipe/s suitable for protein chromatography is/are obtained. The control over so-called Critical Process Parameters like pH, conductivity, buffer concentration of the moving phase in chromatographical setup, are crucial to ensure not only the effectiveness of the production but also the purity profile and thereby the function or effectiveness of the product itself.

In a second embodiment according to the first aspect, the method further comprises running a second set of experiments by further consecutively providing the subset of buffer compositions and the chemical sample as input to the chromatography device, obtaining second results of experiment, RoE, data as output from the chromatography device, wherein the second RoE data is indicative of at least a purity and/or a yield of a wanted substance comprised in the sample, obtaining a second objective function, the second objective function being dependent on the purity and/or the yield, selecting a third subset from the subset, which third subset optimizes the second objective function, and determining the one or more buffer composition recipes for chromatography of a chemical sample as the unique recipes of the third subset.

At least an advantage of this embodiment is that an improved purity and/or yield of a wanted substance is obtained by optimising the buffer composition to be used for chromatography.

In a third embodiment according to the first aspect, the method further comprises performing chromatography of the chemical sample using at least one buffer composition mixed according to the one or more determined buffer composition recipes.

At least an advantage of the invention according to the second embodiment is that an improved purity and/or yield of a wanted substance is obtained by using the optimised buffer composition in the chromatography process. A further advantage is that the quality of the output from the chromatography process is improved by using a buffer composition selected according to the present invention.

According to a second aspect of the invention, the above mentioned and other objectives are achieved with a chromatography apparatus configured for performing chromatography, the chromatography apparatus comprising a plurality of inlets, each inlet coupled to a reservoir and each reservoir configured to hold a fluid, an injection unit coupled to the plurality of inlets and configured to provide a mix of fluids comprised in the plurality of reservoirs as a buffer composition in response to a first control signal, a pH sensor coupled to the injection unit and configured for measuring the pH value of the provided buffer composition, a conductivity sensor coupled to the injection unit and configured for measuring the conductivity of the provided buffer composition, a control unit comprising circuitry comprising a processor, and a memory, said memory containing instructions executable by said processor, whereby said chromatography apparatus is operative to perform the method according to the first aspect.

The advantages of the second aspect are the same as for the first aspect.

According to a third aspect of the invention, the above mentioned and other objectives are achieved with a computer program comprising computer-executable instructions for causing a chromatography apparatus, when the computer-executable instructions are executed on a processing unit comprised in the chromatography apparatus, to perform any of the method steps according to the first aspect.

According to a fourth aspect of the invention, the above mentioned and other objectives are achieved with a computer program product comprising a computer-readable storage medium, the computer-readable storage medium having the computer program according to the third aspect embodied therein.

Further applications and advantages of embodiments of the invention will be apparent from the following detailed description.

### BRIEF DESCRIPTION OF THE DRAWINGS

FIG. 1 shows a buffer composition mixed using a recipe according to one or more embodiments of the present disclosure.

FIG. 2 schematically illustrates design of experiment, DoE, data, results of experiment, RoE, data and prediction of experimental, PoE, data according to one or more embodiments of the present disclosure.

FIG. 3 schematically illustrates an experiment according to one or more embodiments of the present disclosure.

FIG. 4 shows a chromatography apparatus according to one or more embodiments of the present disclosure.

FIG. 5 shows a control unit according to one or more embodiments of the disclosure.

FIG. 6 shows a flowchart of a method according to one or more embodiments of the present disclosure.

FIG. 7 shows details of a flowchart of a method according to one or more embodiments of the present disclosure.

FIG. 8 illustrates how the RoE data 220 may be predicted by the chromatography apparatus 400 according to one or more embodiments of the invention.

FIG. 9 schematically illustrates an objective function dependent on one or more variables according to one or more embodiments of the present invention.

FIG. 10 illustrates an objective function comprising a first pair of objective functions according to one or more embodiments of the present invention.

A more complete understanding of embodiments of the invention will be afforded to those skilled in the art, as well as a realization of additional advantages thereof, by a consideration of the following detailed description of one or more embodiments. It should be appreciated that like reference numerals are used to identify like elements illustrated in one or more of the figures.

### DETAILED DESCRIPTION

An “or” in this description and the corresponding claims is to be understood as a mathematical OR which covers “and” and “or”, and is not to be understand as an XOR (exclusive OR). The indefinite article “a” in this disclosure and claims is not limited to “one” and can also be understood as “one or more”, i.e., plural.

The expression “design range of buffer compositions” is to be interpreted in this disclosure as one or more ranges defining the variable space over which an experiment is conducted on the chromatography apparatus. In other words, this may comprise ranges defining boundaries within fractions of fluid mixed to a buffer composition is varied. In one example, this may define how fractions of fluid, such as acid, base, salt and water, are varied during an experiment.

In the present disclosure reference will be made interchangeably to container or reservoir, signifying a receptacle suitable for holding fluid. In the present disclosure reference will be made interchangeably to processor and processing means.

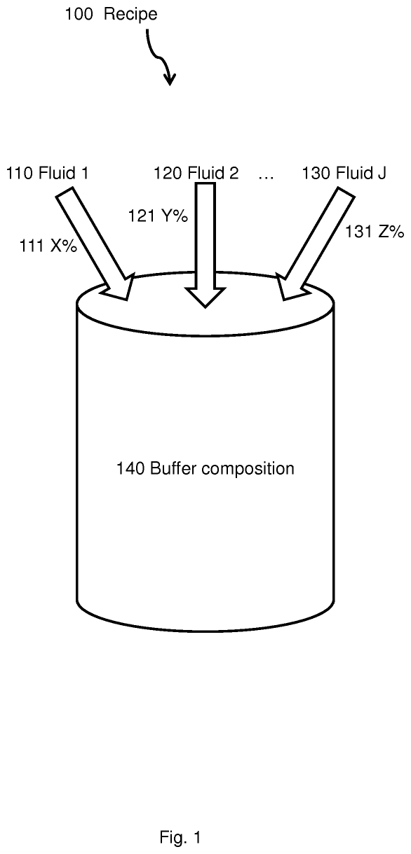

FIG. 1 shows a buffer composition 140 mixed using a recipe 100 according to one or more embodiments of the present disclosure. A recipe 100 of a buffer composition may comprise identity of a plurality of fluids or buffer components 110, 120, 130 and their respective fractions or parts or relative amounts 111, 121, 131 mixed into the buffer composition 140. The recipe 100 may be represented by a data structure or a hardware copy, such as a printout. The recipe 100 may be indicative of an identity of a buffer composition 140, a plurality of fluids or buffer components 110, 120, 130 and their respective fractions or parts or relative amounts 111, 121, 131 when mixed into the buffer composition 140. The recipe is typically used to produce a buffer composition 140 by mixing the buffer components 110, 120, 130 using the respective fractions or parts or relative amounts 111, 121, 131. Recipes that are represented in a set of recipes, e.g. represented in design of experiment, DoE, data 210, where each recipe has a unique combination of fractions or parts or relative amounts 111, 121, 131 is from here on referred to as unique recipes. In other words, in a set of unique recipes no two recipes have the same fractions or parts or relative amounts 111, 121, 131.

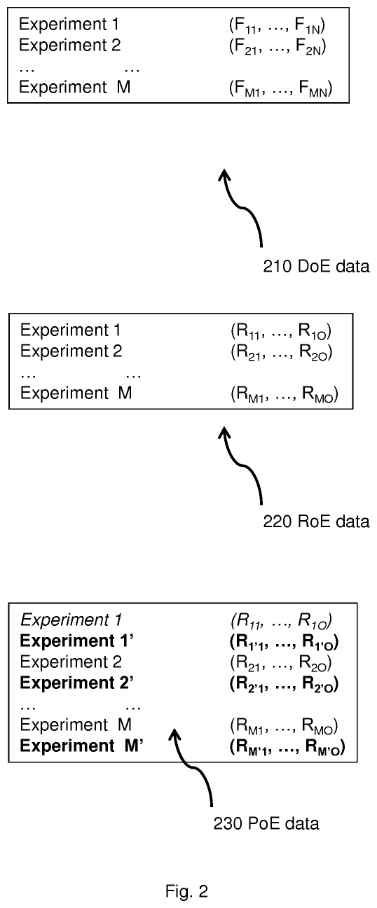

FIG. 2 schematically illustrates design of experiment, DoE, data 210, results of experiment, RoE, data 220 and prediction of experimental, PoE, data 230 according to one or more embodiments of the present disclosure. The DoE data 210 comprises input factors (F₁₁-F_{MN}) that are used when running an experiment (experiment 1-experiment M). DoE data typically comprises a subset of buffer compositions selected from a total set of buffer compositions within a design range. Each row or alternatively each column may represent the input factors of an experiment. Any number of experiments M and any number of input factors N may be defined. In an embodiment, the DoE data 210 is indicative of a set of buffer compositions and corresponding unique recipes 100.

In one example, a unique recipe 100 comprises a line of the factors, comprised in the in the DoE data (F₁₁-F_{1N}). The recipe comprises fractions 111, 121, 131 of a first fluid 110, a second fluid 120 and a third fluid 130 to be mixed into a buffer composition 140 and provided to a chromatography apparatus 400, e.g. fractions of an acid, a base and water in the example.

The PoE data 220 comprises the responses or results (R₁₁-R_{MO}) of each experiment, e.g. obtained by performing measurements using sensors or analytical equipment known in the art on an output fluid from the chromatography apparatus 400. In one example, an experiment using factors F₁₁-F_{1N} will output the corresponding responses or results R₁₁-R_{1O}.

The PoE data 230 comprises predicted responses or results. The PoE data 230 typically expands the RoE data 220 to include further results, points or values within the design range. In FIG. 2, this is illustrated by additional experiments, denoted “Experiment 1′” and “Experiment 2′”, predicted and added to the RoE data. In one or more embodiments the DoE data and/or the PoE data and/or the RoE data may be implemented as a data structure, such as a table.

In one embodiment, the unique recipes 100 indicated by the DoE data 210 comprises constant first fractions 111 of acid and varying second fractions 121 of base. In one example, the varying second fractions 121 of base are varied according to a second gradient.

In one embodiment, the unique recipes 100 indicated by the DoE data 210 comprise varying first fractions 111 of acid and constant second fractions 121 of base. In one example, the varying first fractions 111 of acid are varied according to a first gradient.

In one embodiment, the unique recipes 100 indicated by the DoE data 210 comprise constant first fractions 111 of acid and varying second fractions 121 of base and varying fourth fractions of salt solution. In one example, the varying second fractions 121 of base are varied according to a second gradient and the fourth fractions of salt solution are varied according to a fourth gradient.

In one embodiment, the unique recipes 100 indicated by the DoE data 210 comprise varying first fractions 111 of acid and constant second fractions 121 of base and varying fourth fractions of salt solution. In one example, the varying the first fractions 111 of acid are varied according to a first gradient and the fourth fractions of salt solution are varied according to a fourth gradient.

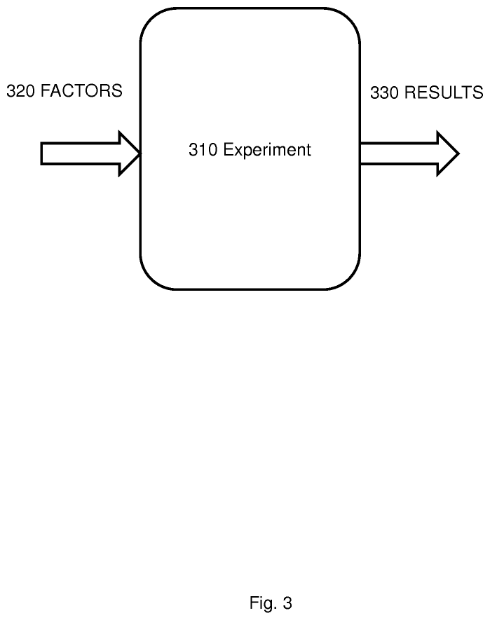

FIG. 3 schematically illustrates an experiment 310 according to one or more embodiments of the present disclosure. A number of factors 320 are defined for the experiment 310, e.g. as DoE data 210. After running the experiment the resulting measurements are aggregated in the results or responses 330, e.g. as RoE data 220.

In an example, the factors 320 are fractions 111, 121, 131 of a first fluid 110, a second fluid 120 and a third fluid 130, i.e. buffer components. E.g. X % of fluid 1, Y % of fluid 2 and Z % of fluid 3. The total of the fraction typically amounts to 100% or substantially 100%. The first fluid 110, the second fluid 120 and the third fluid 130 may be mixed to a buffer composition 140 and provided to a chromatography apparatus 400 or provided to and mixed by the chromatography apparatus 400. The results or responses are pH and conductivity values of the buffer composition 140 measured by the chromatography apparatus 400.

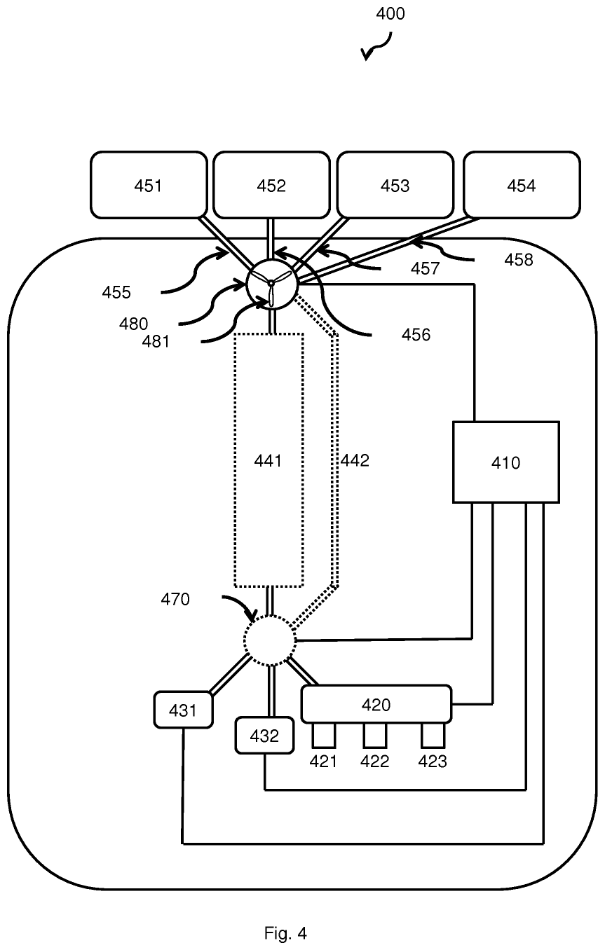

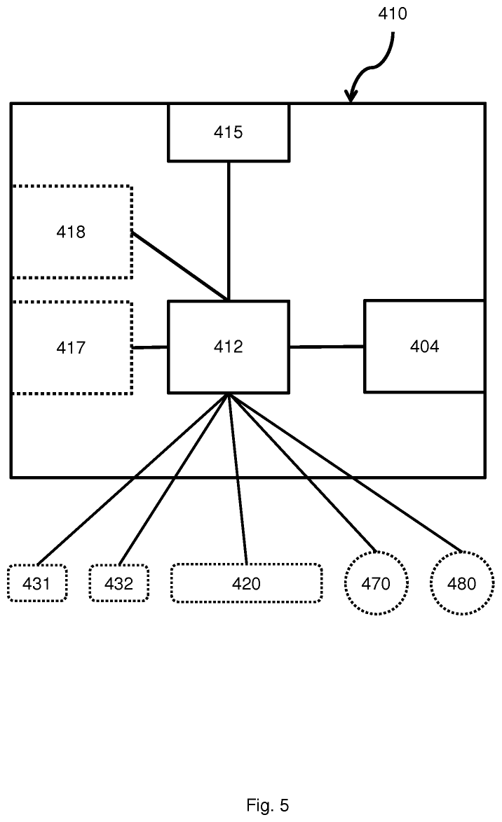

FIG. 4 shows a chromatography apparatus 400 according to one or more embodiments of the disclosure. The chromatography apparatus 400 may typically comprise a plurality of inlets 455-458. Each inlet is coupled to a reservoir 451-454 and each reservoir is configured to hold a fluid, e.g. any of the first fluid 110, the second fluid 120 and the third fluid 130. The inlets 455-458 may e.g. be implemented as tubular elements such as a tube or hose. The chromatography apparatus 400 may further comprise an injection unit 480 coupled to the plurality of inlets 455-458 and configured to provide a mix of the fluids comprised in the plurality of reservoirs 451-454 as a buffer composition 140 in response to a first control signal. The injection unit 480 may comprise a quaternary valve and/or a quaternary pump system and/or a mixer 481 configured to provide the mix of fluids as described above. The chromatography apparatus 400 may further comprise a pH sensor 431 coupled to the injection unit 480 and configured for measuring the pH of the provided buffer composition 140. The chromatography apparatus 400 may further comprise a conductivity sensor 432 coupled to the injection unit 480 and configured for measuring the conductivity of the provided buffer composition 140. The pH sensor 431 and/or the conductivity sensor 432 may further be configured to provide the measured pH and measured conductivity as control signals comprising measurement data to a control unit 410 comprising circuitry. The control unit 410 comprises a processor and a memory. The memory contains instructions executable by the processor, whereby said chromatography apparatus is operative to perform any of the methods described herein. The control unit 410 is further described in relation to FIG. 5. The chromatography apparatus 400 may further comprise an outlet valve 420 coupled to the injection unit 480. The outlet valve 420 may have one or more outlets or outlet ports 421-423 and is configured to provide the buffer composition 140 to the one or more outlets 421-423 in response to a second control signal, e.g. received from the control unit 410. The chromatography apparatus 400 may optionally comprise a splitter 470 coupled to the injection unit 480 and coupled to a selection of any of the pH sensor 431, the conductivity sensor 432 and the outlet valve 420. The splitter 470 may be configured to direct fluid received from the injection unit 480 to any of any of the pH sensor 431, the conductivity sensor 432 and the outlet valve 420, optionally in response to a third control signal. The splitter 470 may be coupled to the injection unit 480 via a column 441 or a column connection 442, such as a tubular element. The outlet valve 420, the pH sensor 431 and the conductivity sensor 432 may be coupled to the injection unit 480 via the splitter 470 and/or the column 441 and/or the column connection 442. The pH sensor 431 and the conductivity sensor 432 may be also connected in series in between the splitter 470 and the outlet valve 420.

FIG. 5 shows the control unit 410 according to one or more embodiments of the present invention. The control unit 410 may be in the form of e.g. an Electronic Control Unit, a server, an on-board computer, a stationary computing device, a laptop computer, a tablet computer, a handheld computer, a wrist-worn computer, a smart watch, a smartphone or a smart TV. The control unit 410 may comprise a processor 412 communicatively coupled to a transceiver 404 configured for wired or wireless communication. The control unit 410 may further comprise at least one optional antenna (not shown in figure). The antenna may be coupled to the transceiver 404 and is configured to transmit and/or emit and/or receive wired or wireless signals in a communication network, such as WiFi, Bluetooth, 3G, 4G, 5G etc. In one example, the processor 412 may be any of a selection of processing circuitry and/or a central processing unit and/or processor modules and/or multiple processors configured to cooperate with each-other. Further, the control unit 410 may further comprise a memory 415. The memory 415 may e.g. comprise a selection of a hard RAM, disk drive, a floppy disk drive, a flash drive or other removable or fixed media drive or any other suitable memory known in the art. The memory 415 may contain instructions executable by the processor to perform any of the methods described herein. The processor 412 may be communicatively coupled to a selection of any of the transceiver 404, the memory 415 the pH sensor 431, the conductivity sensor 432, the outlet valve 420, the splitter 470 and the injection unit 480. The control unit 410 may be configured to send/receive control signals directly to any of the above mentioned units or to external nodes or to send/receive control signals via the wired and/or wireless communications network.

The wireless transceiver 404 and/or a wired/wireless communications network adapter may be configured to send and/or receive data values or parameters as a signal to or from the processor 412 to or from other external nodes. E.g. measured pH or conductivity values.

In an embodiment, the transceiver 404 communicates directly to external nodes or via the wireless communications network.

In one or more embodiments the control unit 410 may further comprise an input device 417, configured to receive input or indications from a user and send a user input signal indicative of the user input or indications to the processing means 412.

In one or more embodiments the control unit 410 may further comprise a display 418 configured to receive a display signal indicative of rendered objects, such as text or graphical user input objects, from the processing means 412 and to display the received signal as objects, such as text or graphical user input objects.

In one embodiment the display 418 is integrated with the user input device 417 and is configured to receive a display signal indicative of rendered objects, such as text or graphical user input objects, from the processing means 412 and to display the received signal as objects, such as text or graphical user input objects, and/or configured to receive input or indications from a user and send a user-input signal indicative of the user input or indications to the processing means 412.

In a further embodiment, the control unit 410 may further comprise and/or be coupled to one or more additional sensors (not shown in the figure) configured to receive and/or obtain and/or measure physical properties pertaining to the chromatography apparatus 400 and send one or more sensor signals indicative of the physical properties to the processing means 412.

In one or more embodiments, the processing means 412 is further communicatively coupled to the input device 417 and/or the display 418 and/or the additional sensors.

In embodiments, the communications network communicate using wired or wireless communication techniques that may include at least one of a Local Area Network (LAN), Metropolitan Area Network (MAN), Global System for Mobile Network (GSM), Enhanced Data GSM Environment (EDGE), Universal Mobile Telecommunications System, Long term evolution, High Speed Downlink Packet Access (HSDPA), Wideband Code Division Multiple Access (W-CDMA), Code Division Multiple Access (CDMA), Time Division Multiple Access (TDMA), Bluetooth®, Zigbee®, Wi-Fi, Voice over Internet Protocol (VoIP), LTE Advanced, IEEE802.16m, WirelessMAN-Advanced, Evolved High-Speed Packet Access (HSPA+), 3GPP Long Term Evolution (LTE), Mobile WiMAX (IEEE 802.16e), Ultra Mobile Broadband (UMB) (formerly Evolution-Data Optimized (EV-DO) Rev. C), Fast Low-latency Access with Seamless Handoff Orthogonal Frequency Division Multiplexing (Flash-OFDM), High Capacity Spatial Division Multiple Access (iBurst®) and Mobile Broadband Wireless Access (MBWA) (IEEE 802.20) systems, High Performance Radio Metropolitan Area Network (HIPERMAN), Beam-Division Multiple Access (BDMA), World Interoperability for Microwave Access (Wi-MAX) and ultrasonic communication, etc., but is not limited thereto.

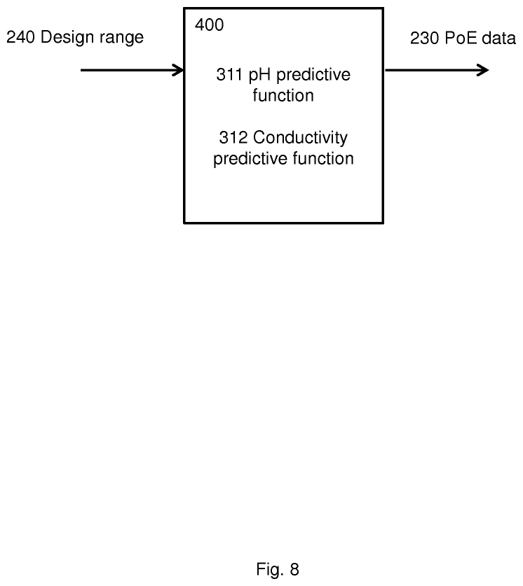

In one embodiment, a method 500 according to the present disclosure is provided. The method 500 may be suitable for determining one or more buffer compositions and/or buffer composition recipes for a chromatography apparatus 400 configured for performing chromatography. The method comprises obtaining 510 design of experiment, DoE, data 210, wherein the DoE data 210 is indicative of a set of buffer compositions and corresponding unique recipes 100. The DoE data 210 may e.g. be retrieved from memory. In an embodiment, the set of buffer compositions is selected as a subset from a total set of buffer compositions within a design range. The method may further comprise running 520 a first set of experiments 310, e.g. using the chromatography apparatus 400. In an example, the experiment is run by consecutively providing buffer compositions 140 mixed according to each unique recipe 100 indicated by the DoE data 210 as the only input to the chromatography apparatus 400. The method may further comprise obtaining 530 results of experiment, RoE, data 220 as output from the first set of experiments 310. In an embodiment, the RoE data 220 is indicative of at least a potential of hydrogen, pH, value of each buffer composition 140 of the set of buffer compositions and/or the total set of buffer compositions. Optionally, the method may further comprise obtaining 540 a first objective function 600. In an embodiment, the first objective function may at least be dependent on a pH value and a conductivity value. The method may further comprise selecting 550 a second subset from the set of buffer compositions and/or from the total set of buffer compositions which corresponding pH values optimize the first objective function. Optionally, the method further comprises determining 560 the one or more buffer composition recipes for chromatography of a chemical sample as the unique recipes corresponding to the second subset. In an embodiment, the method further comprises, obtaining 535 prediction of experimental, PoE data, wherein the PoE data is indicative of at least a predicted pH value and a predicted conductivity value of each buffer composition 140 of the total set of buffer compositions. Predicting pH values and conductivity values are further described in relation to FIG. 8.

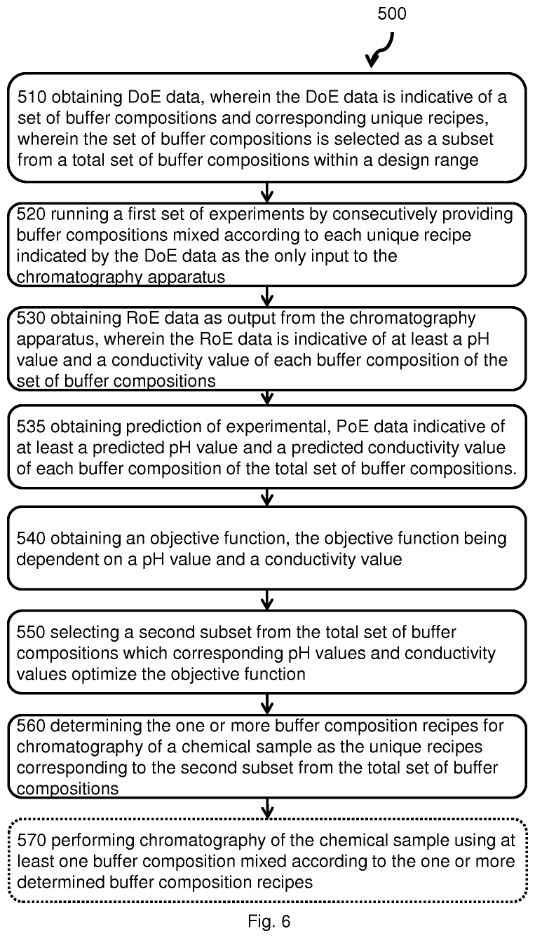

FIG. 6 shows a flowchart of a method 500 according to the present disclosure. The method 500 may be suitable for determining one or more buffer compositions and/or buffer composition recipes for a chromatography apparatus 400 configured for performing chromatography. The method comprises:

obtaining 510 design of experiment, DoE, data 210, wherein the DoE data 210 is indicative of a set of buffer compositions and corresponding unique recipes 100. In an embodiment, the set of buffer compositions is selected as a subset from a total set of buffer compositions within a design range. The method may further comprise running 520 a first set of experiments 310. The step of running 520 may be performed by consecutively providing buffer compositions 140 mixed according to each unique recipe 100 indicated by the DoE data 210, e.g. as the only input to the chromatography apparatus 400. In an embodiment, the method 500 further comprises obtaining 530 results of experiment, RoE, data 220, e.g. as output from the chromatography apparatus 400. The RoE data 220 may be indicative of at least a potential of hydrogen, pH, value of each buffer composition 140 of the set of buffer compositions. In an embodiment, the method 500 further comprises obtaining 535 prediction of experimental or prediction of experiment, PoE data. The PoE data may be indicative of at least a predicted pH value and a predicted conductivity value of each buffer composition 140 of the total set of buffer compositions. In an embodiment, the method 500 further comprises obtaining 540 a first objective function 600, the first objective function being at least dependent on a pH value and a conductivity value. In an embodiment, the method 500 further comprises selecting 550 a second subset from the total set of buffer compositions indicated by the DoE data which corresponding pH values optimize the first objective function. In an embodiment, the method 500 further comprises determining 560 the one or more buffer composition recipes for chromatography of a chemical sample as the unique recipes corresponding to the second subset from the total set of buffer compositions.

In one or more embodiments, wherein the RoE data 220 is further indicative of a conductivity value of each buffer composition 140 of the set of buffer compositions. In one or more embodiments, wherein the PoE data is further indicative of a conductivity value of each buffer composition 140 of the total set of buffer compositions. The first objective function may further be dependent on the conductivity value. In an embodiment, selecting 550 the second subset from the total set of buffer compositions further comprises selecting the second subset which corresponding conductivity values optimize the first objective function.

In an example, this involves selecting buffer compositions which corresponding pH value and/or conductivity values optimize the first objective function

In one or more embodiments, wherein the RoE data 220 is further indicative of a buffer composition concentration value of each buffer composition 140 of the set of buffer compositions, wherein the first objective function is further dependent on a buffer composition concentration value, wherein selecting 550 the second subset from the set of buffer compositions indicated by the DoE data further comprises selecting the second subset which corresponding conductivity values optimizes the first objective function.

In an example, this involves selecting buffer compositions which corresponding pH value and buffer composition concentration value optimize the first objective function

In one or more embodiments, each unique recipe 100 indicated by the DoE data 210 is at least indicative of a first fraction 111 of a first fluid 110, a second fraction 121 of a second fluid 120 and a third fraction 131 of a third fluid 130.

In one or more embodiments, the first fluid 110 is an acid, the second fluid 120 is a base of the acid and the third fluid 130 is water.

In one or more embodiments, each unique recipe 100 indicated by the DoE data 210 is further indicative of a fourth fraction of a fourth fluid, wherein the fourth fluid is a salt solution.

In one or more embodiments, each unique recipe 100 indicated by the DoE data 210 is further indicative of a fourth fraction of a fourth fluid, wherein the fourth fluid is another solution. Examples of such an another solution can be an urea solution, an alcohol solution, a glycos solution, a detergent solution as well as additional acid or base solutions like a EDTA solution and a Tris base solution.

In one or more embodiments, the acid and the base are a conjugate pair.

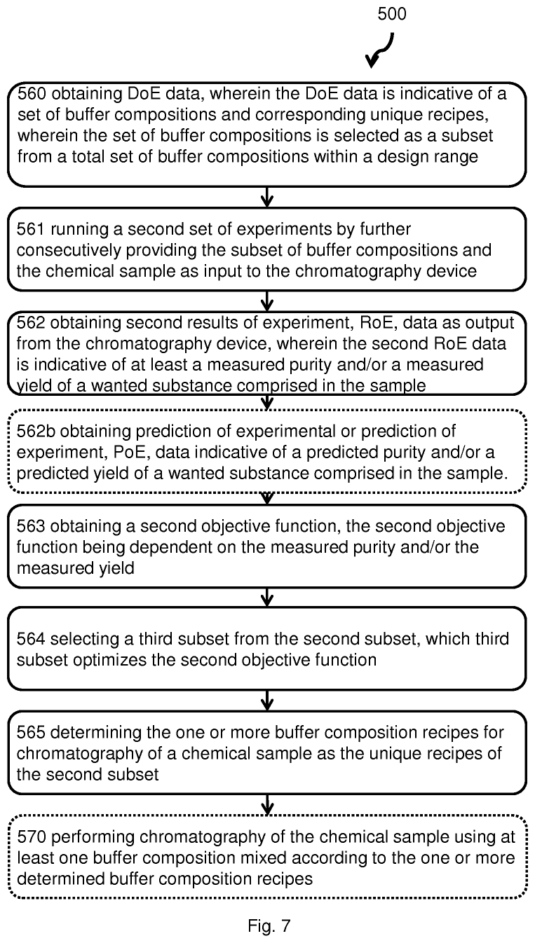

FIG. 7 shows details of a flowchart of the method 500 according to the present disclosure. In one or more embodiments, the method 500 further comprises the steps:

Running 561 a second set of experiments by further consecutively providing the second subset of buffer compositions and the chemical sample as input to the chromatography device.

Obtaining 562 second results of experiment, RoE, data as output from the chromatography device, wherein the second RoE data is indicative of at least a purity and/or a yield of a wanted substance comprised in the sample.

Optionally 562b obtaining prediction of experimental or prediction of experiment, PoE, data indicative of a predicted purity and/or a predicted yield of a wanted substance comprised in the sample.

Obtaining 563 a second objective function, the second objective function being dependent on the purity and/or the yield and/or being dependent on the pH and/or conductivity and/or concentration values.

Selecting 564 a third subset from the second subset, the second subset selected in step 550, which third subset optimizes the second objective function.

Determining 565 the one or more buffer composition recipes for chromatography of a chemical sample as the unique recipes of the third subset.

In one or more embodiments, the method 500 further comprises the steps:

Performing chromatography 570 of the chemical sample using at least one buffer composition mixed according to the one or more determined buffer composition recipes.

An advantage of this embodiment is that the quality of the output from the chromatography process is improved by using a buffer composition selected according to the present invention.

In an embodiment, obtaining 530 results of experiment, RoE, data 220 comprises obtaining the pH value by receiving a measured pH value from the pH sensor 431 and/or receiving a measured conductivity value from the conductivity sensor 432.

FIG. 8 illustrates how the PoE data 230 may be predicted by the chromatography apparatus 400 according to one or more embodiments of the invention. The PoE, data 230, may be obtained by applying a predictive function. A first set of experiments 310 by is run by consecutively providing buffer compositions 140 mixed according to each unique recipe 100 indicated by the DoE data 210 as the only input to the chromatography apparatus 400. As a first step, measured pH values and/or measured conductivity values of a set or a scouting set of buffer compositions selected from the set of buffer compositions are obtained. The scouting may be equal to or smaller than the total set of buffer compositions selected in step 550. The scouting set may be selected according to any conventional method, e.g. every Nth buffer composition of the set of buffer compositions.

In an embodiment, as a second step predicted pH values and/or predicted conductivity values of a remaining set of buffer compositions are obtained The remaining set of buffer compositions including buffer compositions comprised in the set of buffer compositions and excluded from the scouting set of buffer compositions.

At least one advantage of this embodiment is that the time it takes to obtain pH values and/or conductivity values of the entire set of buffer compositions is reduced by measuring pH or conductivity for the scouting set of buffer compositions and predicting the pH or conductivity for the remaining set of buffer compositions.

In an embodiment, as a second step, predicted pH values and/or predicted conductivity values of a extrapolated set of buffer compositions are obtained, the extrapolated set of buffer compositions including buffer compositions having recipes or fractions extrapolated from the set of buffer compositions and being within the design range.

At least one advantage of this embodiment is that a higher resolution of the RoE data 220 compared to the DoE data 210 may be obtained, thus improving the quality of the output from the chromatography process by using a buffer composition selected according to the present invention.

In an embodiment, a computer program comprising computer-executable instructions for causing the chromatography apparatus 400 or the control unit 110, when the computer-executable instructions are executed on a processing unit comprised in the chromatography apparatus 400 or control unit 410, to perform any of the method steps of any of the embodiments described herein.

In an embodiment, a computer program product comprising a memory and/or a computer-readable storage medium, the computer-readable storage medium having the computer program described above embodied therein.

Optimization typically involves selecting one or more best elements with regard a criterion or an objective function dependent on variables from some set of available alternatives. The variables of the objective function may optionally be delimited by constraints or conditions.

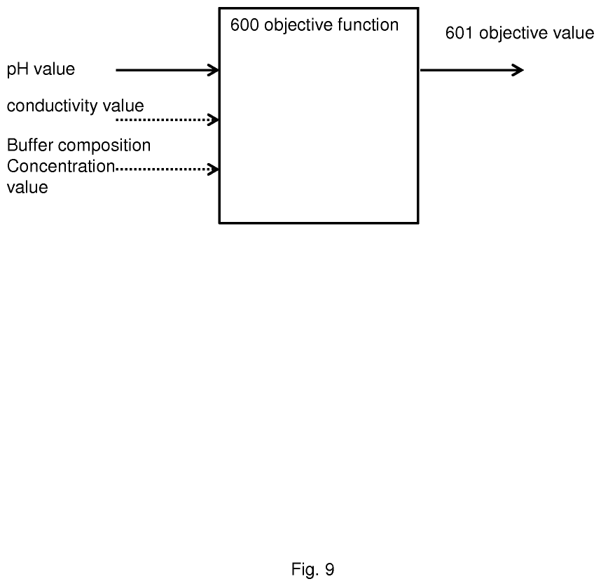

FIG. 9 schematically illustrates an objective function 600 dependent on one or more variables according to one or more embodiments of the present invention. In the example shown in FIG. 9, the variables include a selection of any of a pH value, a conductivity value and Buffer composition concentration value. Depending on the variables, an output value or objective value 601 of the objective function 600 is generated. The value range of the variables may be delimited by a lower constraint and an upper constraint, e.g. indicated in the RoE data. In the example shown in FIG. 9, optimizing the objective function 600 typically involves finding a value or a value range of each variable that maximizes and/or minimizes the objective function 600. Such constraints may e.g. include a pH value range, a conductivity value range and a buffer composition concentration value range.

In one example, pH values indicated by the RoE data that lies within a given pH value range are selected and individually fed to the objective function 600 such that a corresponding objective value 601 is obtained for each of the selected pH values. One or more buffer compositions may then be selected if their corresponding pH values optimizes the objective function 600. This may involve having a maximum objective value 601 or having objective values 601 above a predetermined threshold, .e.g. pH desired min. Alternatively or additionally, this may involve having a minimum objective value 601 or having objective values 601 below a predetermined threshold pH desiredmax.

It is understood that an objective function may be multidimensional and thus be dependent on multiple variables. Optimizing the objective function may involve multidimensional optimization of a plurality of variables.

In an embodiment, the first objective function is dependent on a pH value and/or a conductivity value and/or a buffer composition concentration value.

In one example, the first objective function may be defined as:

$$objective value f ( P ) = \{ \begin{matrix}1 if {ph}_{desiredmin} < P \leq {ph}_{desiredmax} \\ 0 if if {ph}_{desiredmin} > P or P > {ph}_{desiredmax}\end{matrix} \}$$

Where P is a variable indicative of pH, pH desiredmin is a minimum desirable pH and pHdesiredmax is a maximum desired pH. Selecting the second subset from the set of buffer compositions which corresponding pH values optimize the first objective function typically comprises maximizing and/or minimizing the objective value 601 of this objective function.

In one further example, the first objective function may be defined as:

$$objective value f ( C ) = \{ \begin{matrix}1 & if {Conductivity}_{desiredmin} < P \leq {Conductivity}_{desiredmax} \\ 0 & if if {Conductivity}_{desiredmin} > P or P > {Conductivity}_{desiredmax}\end{matrix} \}$$

Where C is a variable indicative of conductivity, Conductivity desiredmin is a minimum desirable conductivity and Conductivity desiredmax is a maximum desired conductivity. Selecting the second subset from the set of buffer compositions which corresponding conductivity values optimize the first objective function typically comprises maximizing and/or minimizing the objective value 601 of this objective function.

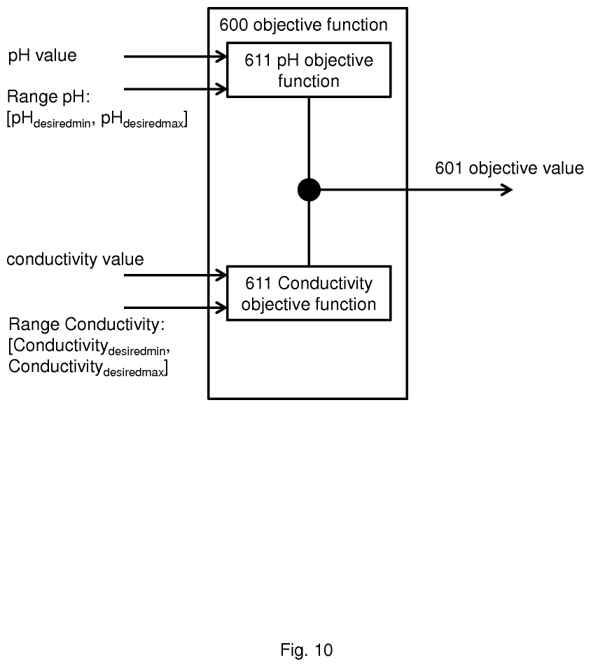

FIG. 10 illustrates an objective function comprising a first pair of objective functions according to the present invention.

In an embodiment, the first objective function 600 comprises a first pair of objective functions 611, 612 comprising a pH objective function 611 and/or a conductivity objective function 612. The pH objective function 611 may be dependent on a set of predicted pH values and a desired pH value range, e.g. [pH desiredmin, pH desiredmax]. The conductivity objective function 612 may be dependent on a set of predicted conductivity values and a desired conductivity value range, e.g. [Conductivity desiredmin, Conductivity desiredmax].

In an embodiment, the set of predicted pH values may at least partially be obtained by applying a pH predictive function 311. Alternatively or additionally the set of predicted conductivity values may at least partially be obtained by applying a conductivity predictive function 312. Applying predictive functions are further described in relation to FIG. 8.

In an embodiment, the pH predictive function is configured to predict pH values of each buffer composition 140 of the set of buffer compositions based on the DoE data and/or the conductivity predictive function is configured to predict conductivity values of each buffer composition 140 of the set of buffer compositions based on the DoE data.

In one example illustrating how the first objective function comprises a pH objective function 611 and a conductivity objective function 612 is shown below:

$$611 ph objective function f ( P ) = \begin{matrix}1 & if ph {desired}_{min} < P \leq ph {desired}_{max} and \\ 0 & if if ph {desired}_{min} > P or P > {desired}_{max} and\end{matrix}$$

$$612 conductivity objective function f ( P , C ) = \begin{matrix}1 & Conductivity {desired}_{min} < P \leq Conductivity {desired}_{max} \\ 0 & if if {Conductivity desired}_{min} > P or P > Conductivity {desired}_{max}\end{matrix}$$

The pH objective function 611 and the conductivity objective function 612 may then be combined to the objective function 600.

$$f ( P , C ) = \begin{matrix}1 \\ \\ 0\end{matrix} \begin{matrix}if ph {desired}_{min} < P \leq ph {desired}_{max} and \\ Conductivity {desired}_{min} < P \leq Conductivity {desired}_{max} \\ \\ if if ph {desired}_{min} > P or P > ph {desired}_{max} and \\ if if {Conductivity desired}_{min} > P or P > Conductivity {desired}_{max}\end{matrix}$$

Where P is a variable indicative of pH, C is a variable indicative of conductivity, as defined above. Optimizing the objective function typically comprises maximizing and/or minimizing this objective function.

In one further example, the first objective function may be defined as:

f(P,C)=k₁*|P−pH desired|+k₂|C−Conductivity desired|

Where P is a variable indicative of pH, C is a variable indicative of conductivity, as defined above, k₁ and k₂ constants and pH desired and Conductivity desired are target values of pH and conductivity. Optimizing the objective function typically comprises minimizing and/or maximizing this objective function.

In an embodiment, the second objective function is dependent on purity and/or yield.

In one further example, the second objective function may be defined as:

f(Y)=|Y−Yield desired|

Where Y is a variables indicative of yield. Yield desired is a target value of yield. Optimizing the objective function typically comprises minimizing and/or maximizing this objective function.

In one further example, the second objective function may be defined as:

f(PUR)=|PUR−Purity desired|

Where PUR is a variables indicative of purity of the chromatography apparatus output fluid, e.g. in terms of a wanted protein. Purity desired is a target value of purity. Optimizing the objective function typically comprises minimizing and/or maximizing this objective function.

Moreover, it is realized by the skilled person that the control unit 410 may comprise the necessary communication capabilities in the form of e.g., functions, means, units, elements, etc., for performing the present solution. Examples of other such means, units, elements and functions are: processors, memory, buffers, control logic, encoders, decoders, rate matchers, de-rate matchers, mapping units, multipliers, decision units, selecting units, switches, interleavers, de-interleavers, modulators, demodulators, inputs, outputs, antennas, amplifiers, receiver units, transmitter units, DSPs, MSDs, TCM encoder, TCM decoder, power supply units, power feeders, communication interfaces, communication protocols, etc. which are suitably arranged together for performing the present solution.

Especially, the processor and/or processing means of the present disclosure may comprise one or more instances of processing circuitry, processor modules and multiple processors configured to cooperate with each-other, Central Processing Unit (CPU), a processing unit, a processing circuit, a processor, an Application Specific Integrated Circuit (ASIC), a microprocessor, a Field-Programmable Gate Array (FPGA) or other processing logic that may interpret and execute instructions. The expression “processor” and/or “processing means” may thus represent a processing circuitry comprising a plurality of processing circuits, such as, e.g., any, some or all of the ones mentioned above. The processing means may further perform data processing functions for inputting, outputting, and processing of data comprising data buffering and device control functions, such as call processing control, user interface control, or the like.

Finally, it should be understood that the invention is not limited to the embodiments described above, but also relates to and incorporates all embodiments within the scope of the appended independent claims.

1. A method for determining one or more buffer composition recipes for a chromatography apparatus configured for performing chromatography, the method comprising:
obtaining design of experiment, DoE, data, wherein the DoE data is indicative of a set of buffer compositions and corresponding unique recipes, wherein the set of buffer compositions is selected as a subset from a total set of buffer compositions within a design range,
running a first set of experiments by consecutively providing buffer compositions mixed according to each unique recipe indicated by the DoE data as the only input to the chromatography apparatus,
obtaining results of experiment, RoE, data as output from the chromatography apparatus, wherein the RoE data is indicative of at least a potential of hydrogen, pH, value and a conductivity value of each buffer composition of the set of buffer compositions,
obtaining prediction of experimental, PoE data, wherein the PoE data is indicative of at least a predicted pH value and a predicted conductivity value of each buffer composition of the total set of buffer compositions,
obtaining a first objective function, the first objective function being dependent on a pH value and a conductivity value,
selecting a second subset from the total set of buffer compositions which corresponding pH values and conductivity values optimize the first objective function,
determining the one or more buffer composition recipes for chromatography of a chemical sample as the unique recipes corresponding to the second subset from the total set of buffer compositions.

2. The method according to claim 1, wherein the first objective function comprise a first pair of objective functions comprising a pH objective function and a conductivity objective function, wherein the pH objective function is dependent on a set of predicted pH values and a desired pH value range and the conductivity objective function is dependent on a set of predicted conductivity values and a desired conductivity value range.

3. The method according to claim 2, wherein the set of predicted pH values is obtained by applying a pH predictive function and the set of predicted conductivity values is obtained by applying a conductivity predictive function.

4. The method according to claim 1, wherein each unique recipe indicated by the DoE data is at least indicative of a first fraction of a first fluid, a second fraction of a second fluid and a third fraction of a third fluid.

5. The method according to claim 4, wherein the first fluid is an acid, the second fluid is a base of the acid and the third fluid is water.

6. The method according to claim 5, wherein each unique recipe indicated by the DoE data is further indicative of a fourth fraction of a fourth fluid, wherein the fourth fluid is a salt solution.

7. The method according to claim 6, wherein the fourth fluid is used to adjust the conductivity and the first fraction and the second fraction are constrained by a given buffer concentration

8. The method according to claim 5, wherein each unique recipe indicated by the DoE data is further indicative of a fourth fraction of a fourth fluid, wherein the fourth fluid is another solution.

9. The method according to claim 5, wherein the acid and the base are a conjugate pair, and where the first fraction and the second fraction are constrained by a given buffer concentration.

10. The method according to claim 1, further comprising:
running a second set of experiments by further consecutively providing the second subset of buffer compositions and the chemical sample as input to the chromatography device,
obtaining second results of experiment, RoE, data as output from the chromatography device, wherein the second RoE data is indicative of at least a purity and/or a yield of a wanted substance comprised in the sample,
obtaining prediction of experimental or prediction of experiment, PoE, data indicative of a predicted purity and/or a predicted yield of a wanted substance comprised in the sample,
obtaining a second objective function, the second objective function being dependent on a purity and/or a yield,
selecting a third subset from the second subset, which third subset optimizes the second objective function, and
determining the one or more buffer composition recipes for chromatography of a chemical sample as the unique recipes of the third subset.

11. The method according to claim 1, further comprising:
performing chromatography of the chemical sample using at least one buffer composition mixed according to the one or more determined buffer composition recipes.

12. The method according to claim 5, wherein the unique recipes indicated by the DoE data comprises constant first fractions of acid and varying second fractions of base.

13. The method according to claim 5, wherein the unique recipes indicated by the DoE data comprises varying first fractions of acid and constant second fractions of base.

14. The method according to claim 6, wherein the unique recipes indicated by the DoE data comprises constant first fractions of acid and varying second fractions of base and varying fourth fractions of salt solution.

15. The method according to claim 5, wherein the unique recipes indicated by the DoE data comprises varying first fractions of acid and constant second fractions of base and varying fourth fractions of salt solution.

16. A chromatography apparatus configured for performing chromatography, the chromatography apparatus comprising:
a plurality of inlets, each inlet coupled to a reservoir and each reservoir configured to hold a fluid,
an injection unit coupled to the plurality of inlets and configured to provide a mix of fluids comprised in the plurality of reservoirs as a buffer composition in response to a first control signal,
a pH sensor coupled to the injection unit and configured for measuring the pH value of the provided buffer composition,
a conductivity sensor coupled to the injection unit and configured for measuring the conductivity of the provided buffer composition,
a control unit comprising circuitry comprising:
a processor, and
a memory, said memory containing instructions executable by said processor, whereby said chromatography apparatus is operative to perform the method according to claim 1.

17. The chromatography apparatus according to claim 16, wherein the injection unit comprises a quaternary valve.

18. The chromatography apparatus according to claim 16, the chromatography apparatus further comprising:
an outlet valve coupled to the injection unit and one or more outlets and configured to provide the buffer composition to the one or more outlets in response to a second control signal.

19. The chromatography apparatus according to claim 16, the chromatography apparatus further comprising:
a splitter coupled to the injection unit and a selection of the pH sensor, the conductivity sensor and the outlet valve.

20. The chromatography apparatus according to claim 19, wherein the splitter is coupled to the injection unit or a column connection.

21. A computer program comprising computer-executable instructions for causing a chromatography apparatus, when the computer-executable instructions are executed on a processing unit comprised in the chromatography apparatus, to perform any of the method steps of claim 1.

22. A computer program product comprising a computer-readable storage medium, the computer-readable storage medium having the computer program according to claim 21 embodied therein.
